(19) United States
(12) Patent Application Publication
(10) Pub. No.: US 2017/0345192 A1
(43) Pub. Date: Nov. 30, 2017

(54) SYSTEMS AND METHODS FOR DISPLAYING CONTENT OF DIGITAL MEDIA

(71) Applicant: Apple Inc., Cupertino, CA (US)

(72) Inventors: Jaden M. GELLER, Folsom, CA (US); Casey M. DOUGHERTY, San Francisco, CA (US)

(21) Appl. No.: 15/243,848

(22) Filed: Aug. 22, 2016

Related U.S. Application Data
(60) Provisional application No. 62/216,961, filed on Sep. 10, 2015.

(51) Int. Cl. G06T 11/40; G06T 3/40; G06K 9/46; G06K 9/62; G06F 3/0483

(52) U.S. Cl. CPC G06T 11/40; G06K 9/46; G06K 9/6215; G06T 3/40; G06F 3/0483; G06T 2207/20112; G06K 2009/4666

(57) ABSTRACT

An electronic device for displaying digital media having a page with a page aspect ratio, the electronic device including a display for displaying the page, the display having a display aspect ratio and memory configured to receive and store the digital media. The electronic device can include a processor configured to analyze the page to detect content and a page background on the page, the page background being the areas of the page that are not content. The processor can determine if a portion of the display will not be filled with background or content when displaying the page, and render an extended background that looks substantially similar to the background for displaying with the page on the display.

### CROSS-REFERENCE TO RELATED APPLICATIONS

The present application claims the benefit of U.S. Provisional Application No. 62/216,961, entitled “SYSTEMS AND METHODS FOR DISPLAYING CONTENT OF DIGITAL MEDIA” filed Sep. 10, 2015, the content of which is incorporated herein by reference in its entirety for all purposes.

### FIELD

The present disclosure relates generally to applications for displaying digital media on a computing device. More specifically, the present embodiments relate to graphical user interface effects for displaying content in digital media at the computing device when viewing and navigating the digital media.

### BACKGROUND

The prevalence of portable computing devices has lead to the popularity of digital media that can be accessed from almost anywhere at anytime. Some forms of digital media include digital books that include text and images. When viewed on an electronic device, and in particular portable electronic devices, some digital books can be tedious for a user to navigate through, because of the organization of the images in the digital books. For example, a user may be required to manually navigate through and center certain images without any assistance from the portable device. As a result, the user may spend more time thinking about how to position the images than absorbing the material they are viewing.

Also, in the case of comic books for example, a page size might be set by an author, publisher or standard based on print media. Yet, screen sizes and resolutions vary across the numerous kinds of electronic viewing devices that can access digital content. While size affects how a page is displayed, more importantly, the proportions of a display screen may be such that the page does not match the display screen. When a page of a digital comic book is displayed for example, if the proportions of the page do not match the proportions of the screen, either part of the page must be clipped or the page is backfilled, often with black or white bars above and below (or to the right and left) of the screen, to fill the display screen. Stretching the media to fit the display proportions tends to distort the media providing an undesirable viewing experience.

### SUMMARY

This paper describes various embodiments that relate to methods and systems for displaying and navigating contents on an electronic device. In some embodiments relate to defining contents for the display and navigation on an electronic device.

Some embodiments include an electronic device for displaying digital media having a page with a page aspect ratio, the electronic device including a display for displaying the page, the display having a display aspect ratio and memory configured to receive and store the digital media. The electronic device can include a processor configured to analyze the page to detect content and a page background on the page, the page background being the areas of the page that are not content. The processor can determine if a portion of the display will not be filled with background or content when displaying the page, and render an extended background that looks substantially similar to the background for displaying with the page on the display.

In some embodiments the extended background can be rendered by sampling a value of the page background. In some embodiments the processor can determine if the page aspect ratio does not match display aspect ratio and can display the entire page with the extended background to fill the display. In some embodiments the display can display the content in an enlarged state, a portion of the background and the extended background to fill the display. In some embodiments the content is displayed in the enlarged state and the content is further displayed in a parallax effect.

Some embodiments can include a method for rendering an extended background to fill a display of an electronic device for displaying digital media including content and a page background where the method can include detecting content on the page and the page background, the page background being the areas of the page that are not content and sampling the page background. The method can include rendering an extended background to be displayed next to the page background when the page does not fill the display.

In some embodiments sampling of the page background is performed at a portion of the page adjacent an area of the display where the page will not fill when the page is displayed on the display. In some embodiments the portion of the page sampled is both a top portion and a bottom portion when a top area and bottom area of the display are not filled with the page background when the page is displayed. In some embodiments the portion of the page sampled is both a left portion and a right portion when a left area and right area of the display are not filled with the page background when the page is displayed. In some embodiments the sampling of the page background includes evaluating a measure of at least one of a color, brightness, contrast, luminosity and saturation.

In some embodiments the content is displayed in prominent state. In some embodiments the prominent state includes a parallax effect and/or an enlarged state. In some embodiments the page comprises multiple pieces of content that are each displayed in the prominent state and the multiple pieces of content can be displayed on different layers that have varying parallax effects. In some embodiments the multiple pieces of content can overlap. In some embodiments the digital media is a comic book, and the content includes graphics panels on the page. In some embodiments the content can further include text bubbles that are displayed in parallax effect.

Some embodiments include a non-transitory machine-readable storage medium to store instructions that when executed by a processor of a computing device having a display cause the computing device to perform steps that can include reading a page of digital media having content and a page background, the page background being the areas of the page that are not content and determining the page background attributes at the page edges. The instructions can include rendering an extended background using the background attributes to be displayed next to the page edge when the page does not fill the display and the page edge and extended background are substantially similar.

In some embodiments the background attributes include at least one of a color, brightness, contrast, luminosity and saturation. Some embodiments can include the step of applying a parallax effect to the content when the content is displayed on the display. In some embodiments the page can include multiple pieces of content and can apply a parallax effect can be applied to each multiple piece of content when displaying more than one piece of content on the display.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings.

FIG. 1 shows a diagram for creating, distributing and displaying digital media such as a comic book in accordance with some embodiments.

FIG. 2 shows an electronic device displaying a digital media page with content panels in accordance with some embodiments.

FIG. 3 shows an alternatively configured electronic device displaying a digital media page with content panels in accordance with some embodiments.

FIG. 4 shows the electronic device of FIG. 3 displaying content and an extended background in accordance with some embodiments.

FIG. 5A shows a display of an electronic device rotated to the left and content being displayed in parallax effect in accordance with some embodiments.

FIG. 5B shows a display of an electronic device rotated to the right and content being displayed in parallax effect in accordance with some embodiments.

FIG. 6 shows a flow chart of a method for displaying content with an extended background in accordance with some embodiments.

FIG. 7 is a block diagram of a computing device that can represent the components of the electronic device in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Comic books, and similar media, are primarily graphic based, having graphics panels that are read in a particular order to follow the sequence of the story. Typically, comic books are read starting at the top and moving left to right when the comic is in English, or right to left when in Japanese. Reading comics on a digital device is done in much the same way. That said, some digital devices, depending on the screen size, can make viewing the particular panels difficult when a whole page is displayed on a smartphone display, for instance. Zooming in and out and moving around on a page is sometimes possible, but the interaction experience is cumbersome. Navigating around the page to view the comic book panels by manually manipulating the page while reading, feels unnatural leaving much to be desired in the way of a user experience. While comic books are mostly graphic, they usually contain text within the panels. The text itself can often be stylized to coordinate with the graphically focused storytelling theme of a comic. Even displaying the text in a zoomed manner can leave much to be desired. The embodiments described herein ameliorate many of these problems and provide an enriched user experience to users when viewing digital media on electronic devices.

Described embodiments generally relate to methods and systems for displaying and navigating content on an electronic device. Some embodiments relate to displaying the content on a portable electronic device such as a tablet or smartphone, smart on which the content resides with an extended background to fill the display. Some embodiments display particular content for an enhanced viewing experience and can display the content using a parallax effect to isolate and prominently display the content as well as to provide the simulated experience of having the content appear to be displaced three-dimensionally on a two-dimensional display.

Some embodiments provide a method for sampling a background and rendering a full screen rendition of a page of digital media having content on a display. Embodiments can render a page as a whole and filling the screen with background regardless of the size of the page of digital media and without using white or black screen fill bars. Some embodiments can use the same method of sampling for providing a background behind content in the case where specific content is selected for isolated viewing.

When displaying content, some embodiments can use a content map either provided by an author or publisher or detected automatically and can display a particular content panel in a more prominent manner, such as enlarged and isolated, on the screen of an electronic device so it is easier to see. The content can be displayed in response to an input received from a user. The content can also be displayed automatically, for instance as a first content panel in a comic book when beginning navigation of the book. Displaying the content in an isolated enlarged state is particularly useful in small portable electronic devices such as smartphones, but is helpful on many electronic devices for a better viewing experience. Once a content panel is more prominently displayed, navigation can be performed, from input by a user, or automatically, along the natural progression of the contents on the page. Navigation can also proceed to any other content on a page, as dictated by the input of the user. Various types of input can lead to any number of ways of navigating around the contents of a page or even back to the entire page as a whole.

In some embodiments, content can be zoomed in on and/or shown in darker, bolder, display resolution than its surroundings. In some embodiments, when a panel is enlarged or zoomed in on, the panel can fill the entire display along its width from left to right. In some embodiments, the content can be further enlarged in response to a user input and the content can fill the display from top to bottom. Depending on the configuration of the content, the display can crop part of the content. In this case the content can be moved left to right, by a user input such as dragging, to move all areas of the content around to be seen within the display screen. In some embodiments, a page can have a different aspect ratio than the display. In this circumstance, an extended background can be rendered with the page background to fill the display.

When displaying a particular content or a content panel, some embodiments can use a filter that displays the rest of the page including adjacent content, as faded into the background. That is, some embodiments can allow viewing selected content in the context of the page, with the other content and/or content panels faded into the background. In some embodiments, the color of the page background (or a predominant color of the page) can be analyzed to give the background filter a predominant color. In some embodiments, a filter that can both de-emphasize the hard edges of a content or content panel can be used. This filter can provide a feathering effect and/or provide the appearance of the color “bleeding” out of the lines, with the lines becoming less prominent can be used. A filter can also be used to blur the non-selected content and/or content panels.

Some embodiments can center a selected content panel on the display. In such cases a portion of the display screen area may not be occupied by a portion of the digital media page or content. For example, if a centered content panel is at the top of a page of digital media, then in some cases the top of the display screen will not be filled with the page background. Some embodiments can use the page background color to fill this region, rather than displaying the region in a solid black or white.

When displaying selected content or content panel some embodiment can apply a parallax effect to the selected content or content panel of a digital media. This can display the selected panel as appearing to float “above” the background. In the case of comic books for example, some embodiments can display speech bubbles and the like in a parallax and/or isolated manner, and can provide these as a separate layer above the rest of the panel, with further parallax effect.

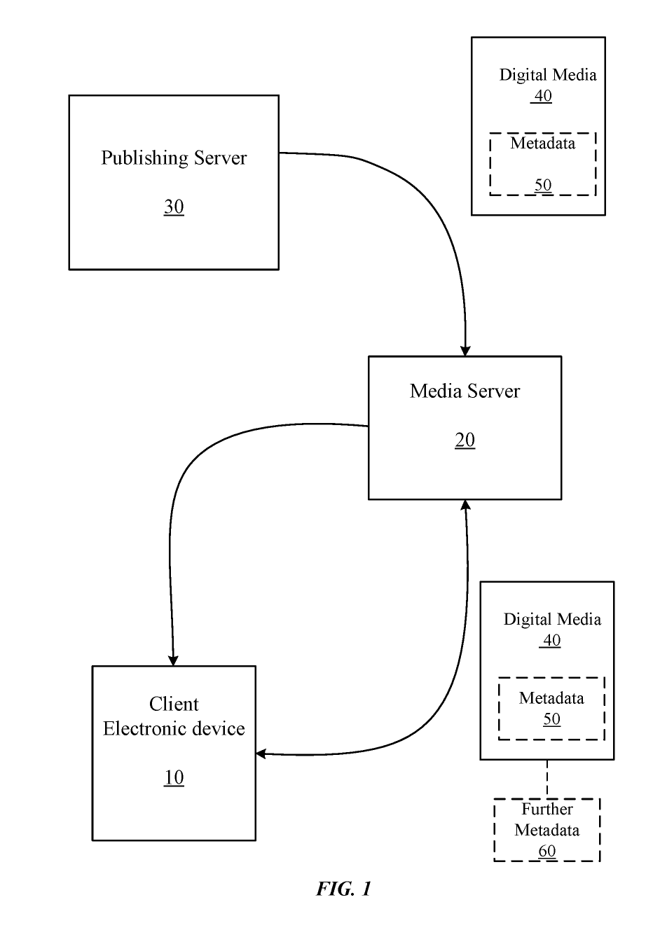

These and other embodiments are discussed below with reference to FIGS. 1-7; however, those skilled in the art will readily appreciate that the detailed description given herein with respect to these figures is for explanatory purposes only and should not be construed as limiting.

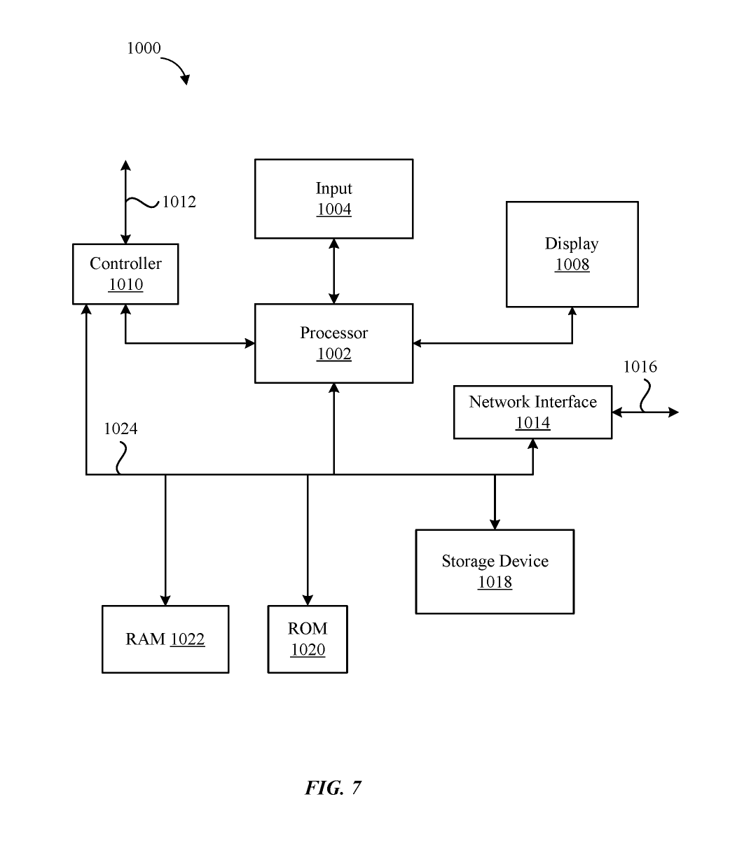

FIG. 1 shows a system for creating, distributing and displaying digital media 40. Digital media 40 can be created and stored on a publishing server 30 maintained by a publisher or author of digital media 40. Digital media 40 can take many forms such as comic books, recipe books, photo albums and other graphic intensive media. Publishing server 30 can be connected to a media server 20 for distributing digital media 40 to consumers. Media server 20 can include various distribution forms such as selling, licensing or renting and so on. Media server 20 can have a storefront for consumers to access for previewing, viewing and obtaining digital media 40. Media server 20 can have an applications store for providing an application for displaying the media as well as facilitating the ability to purchase digital media if applicable. Media server 20 can facilitate financial transactions for such purchases. Access to media server 20 and digital media 40, via the applications store for example, can be done by an electronic client device 10. Electronic client device 10 can take many forms such as a tablet, smartphone, watch, desktop computer, smart television and so on. The configuration of electronic device 10 is discussed in greater detail below with regard to FIG. 7.

Media server 20 can be configured to perform the method of some embodiments discussed herein. Specifically, embodiments with regard to auto-detection of content in digital media 20 can be performed at media server 20. Embodiments for auto-detection can also be performed at electronic client device 10 and/or at publishing server 30. Metadata 50 can accompany digital media 40. Metadata 50 can be generated at any of publishing server 30, media server 20 and/or electronic client device 10. In the illustrated embodiment metadata 50 can be in the form of content mapping prepared by the publisher or author that is associated with digital media 20. Digital media can be transmitted to media server 20 with metadata 50. Media server can perform methods in accordance with described embodiments and utilize metadata 50 and/or generate additional metadata 60. Additional metadata 60 can also be generated by electronic client device 10.

By way of example, a publisher might provide digital media 40 with a content map providing size, shape and location of the content in digital media 40. The publisher may not however provide any information on a navigation sequence in the content map. Media server 20 can perform the method in accordance with some embodiments described and auto-determine the navigation sequence from the size shape and location of the content as dictated by the content map and the language of digital media, such as English, which can also be included in metadata 50. The method for determining the navigation sequence can result in additional metadata 60 that can be associated with digital media 20. Digital media 20 with both metadata 50 and additional metadata 60 can be transmitted to electronic client device 10 for displaying digital media 40 to a consumer in an enriched user experience in accordance with some embodiments described herein.

Alternatively, a publisher may not provide any content information at all and only an image file of each page of digital media 40 is available. Then Media server and/or electronic client device 10 can perform the method of some embodiments and auto detect the content in digital media 40 and then associate this information with digital media 40. At this point digital media with the associated metadata 60 having the content map can be communicated between publishing server, medias server and/or electronic client device 10 as the circumstance permits.

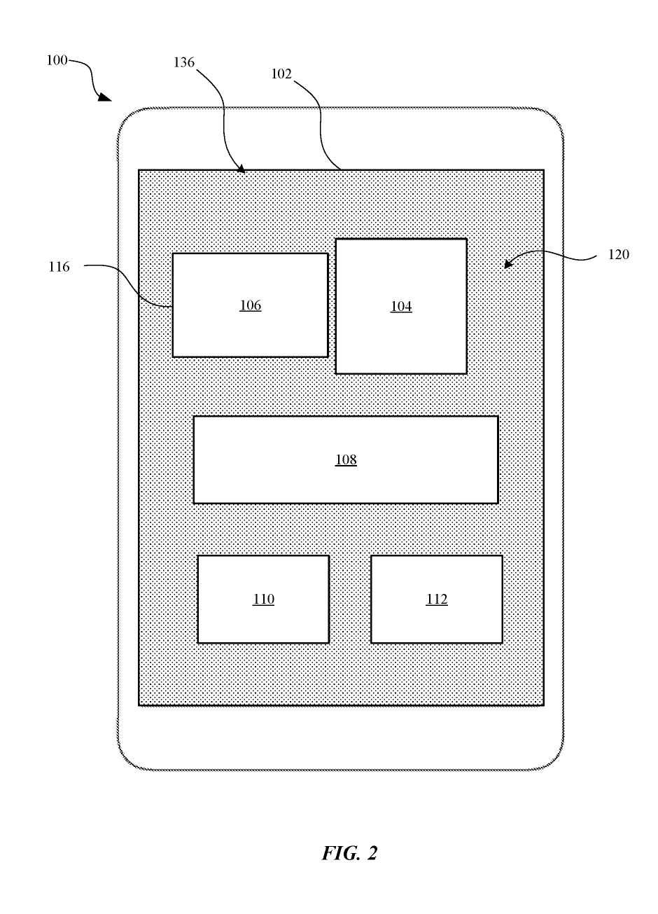

FIG. 2 shows an electronic device 100 having a display screen 102 for viewing a page 136 having content on electronic device 100. Display 102, can be a touchscreen interface that can communicate with a processor, shown in FIG. 7 and described further below. Display 102 can display digital media content such as comic books for viewing by a user. Content 106, 104, 108, 110 and 112, are illustrated as being displayed on page 136 displayed on display 102 and can take the form of panels or any other shape or configuration envisioned by an author as is common in comic books and similar digital media. A background 120 can surround content 106, 104, 108, 110 and 112. Background 120 is shown as uniform here, but can take many forms and can be solid, have a gradient appearance, or include graphics renditions, tonal and/or color variations, among numerous other options. Content 106, 104, 108, 110 and 112 combined with background 120 can make up a page (136). Digital media 40 can consist of one or multiple pages. Each page, as illustrated can have multiple pieces of content and/or a single piece of content. Content 106, 104, 108, 110 and 112 can overlap in some configurations and can have a boarder 116 for each respective panel.

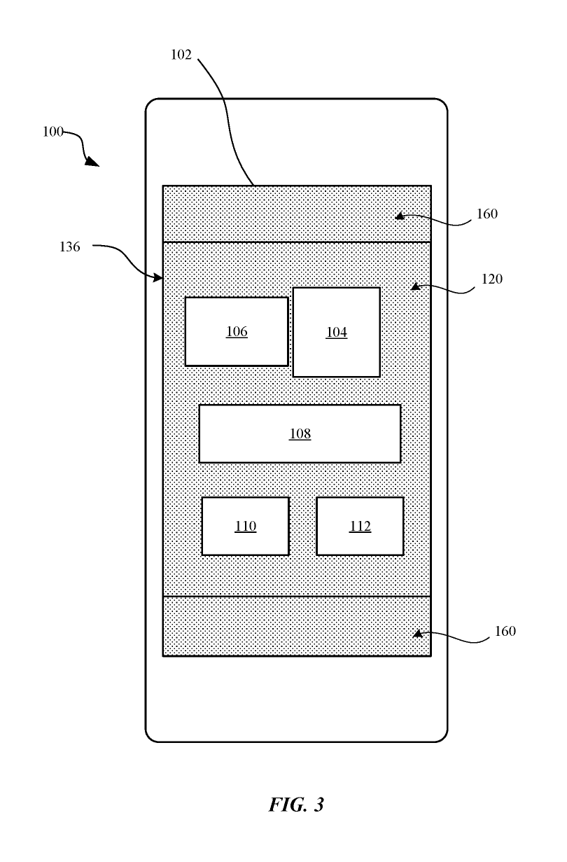

FIG. 3 shows an alternatively configured electronic device 100. Since there are many different display sizes and resolutions of electronic devices and digital media, page sizes do not necessarily correlate to the proportions of all screens and thus the aspect ratio of display 102 is different. Here, electronic device 100 is more elongated than electronic device 100 of FIG. 2. Thus, if page 136 were displayed at display 102, there would be areas of the display not filled with page 136. Some embodiments can render an extended background 160 to be displayed adjacent page 136 to fill display 102. Extended background 160 can be rendered in a single portion, multiple joined or disjoined portions, like a top and bottom portion as shown here, or many portions. In some embodiments the page 136 could be uneven or the content displayed may have an incongruous shape and extended background 160 can fill the space between the incongruous shape and the display edge.

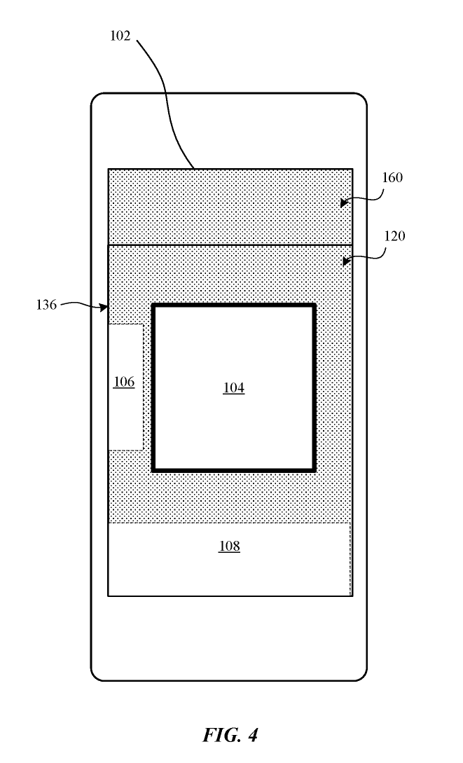

As mentioned, content attributes such as size shape and location can be provided with digital media or detected automatically. The content can then be selectively viewed and navigated. FIG. 4 shows display 102 with content 104 being highlighted to show that it has been selected by a touch interface input and displayed in a prominent enlarged manner on display 102. Content 106 and 108 are shown in dashed lines to signify being displayed on display 102 in a muted, blurred and/or faded manner so as to contrast with content 104. In some embodiments, when a content is enlarged or zoomed in on, the content and page background, can fill the entire display along its width from left to right and on the bottom, but not necessarily the top, as shown for example. Alternatively, when content is enlarged or zoomed in on, the content and page background, can fill the entire display along its width from top to bottom, but not necessarily left or right. Other configurations are also possible where the areas of page 136 do not fill the entire display 102. In these cases, extended background 160 can fill those areas that would otherwise not be filled with page 136 or content such as content 104 so that the page background looks like it fills the entire screen, since the extended background can be rendered to look substantially similar to page background 120.

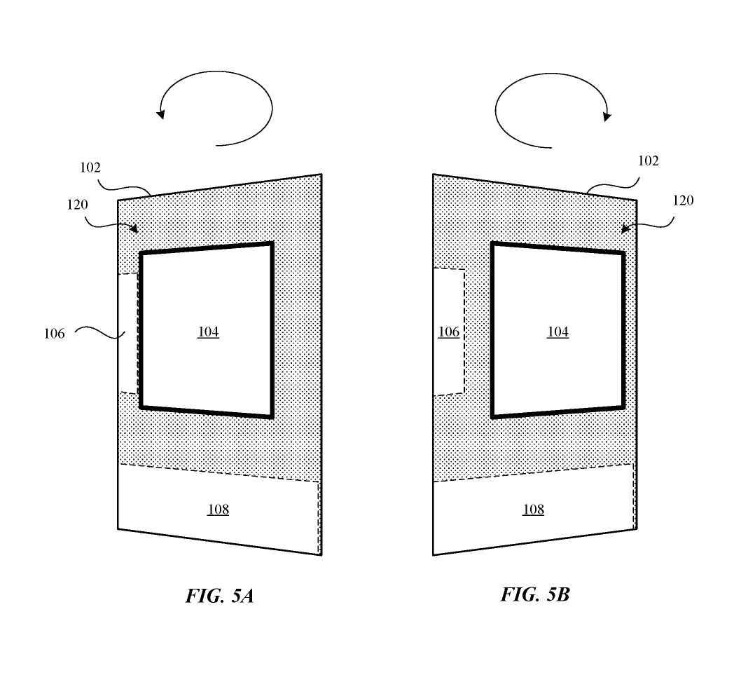

When content is displayed and navigated it can be displayed in parallax effect. FIG. 5A and FIG. 5B show a schematic of content and a portion of a page of digital media with the content shown in a parallax effect for a left and right position of a display, respectively. FIG. 5A and FIG. 5B show the same portion of page 136 shown in FIG. 4, this time without extended background 136 and with display 102 of electronic device 100, but without the exterior of electronic device 100 itself. FIG. 5A shows display 102 rotated to the left with content 104 displayed in an enlarged highlighted state in parallax effect. When content 104 is viewed in this rotation, content 106, appears closer to content 104. This is because the parallax effect causes content 104 appear to float at a layer above content 106 and 108. Thus, content 104 appears to almost overlap content 106. FIG. 5B shows display 102 rotated to the right. In this state, content 104 appears further from content 106 since content 104 appears to hover above the page background 120 and content 106 and 108. Thus, the space between content 106 and content 104 is larger given the appearance that content 104 is floating. As display 102 of electronic device 102 is rotated, content 104 can be made to appear to move across the screen with respect to the other content giving a motion effect, when display 102 is in motion. Displaying the content in the parallax effect provides an enriched dynamic user experience that can make a user feel like the digital media being viewed has an animated effect to it. This is particular beneficial in comic books, graphic novels and the like for enriching the user experience.

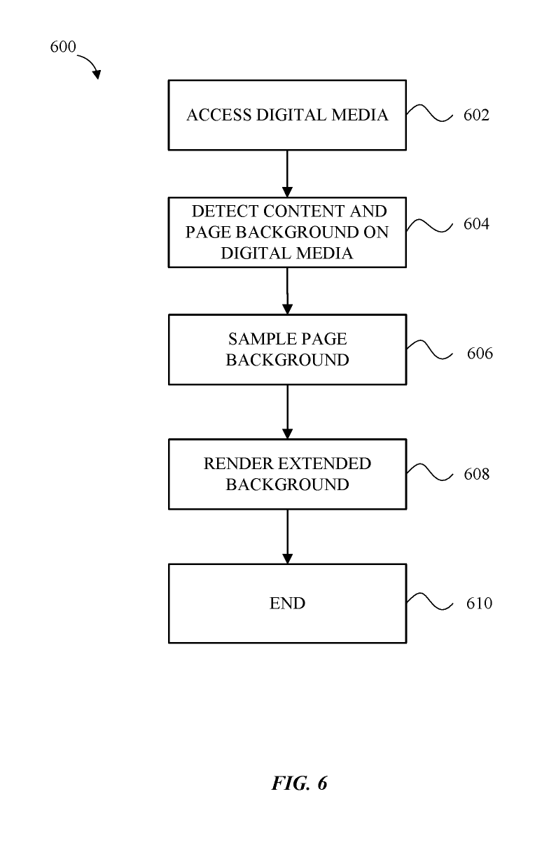

FIG. 6 shows a flow chart of a method 600 for displaying a page or portion thereof, of digital media having content on a display. In a first step 602 the digital media is accessed. In a subsequent step 604, information about the page of the digital media is determined. Method 600 can detect content on the page in a second step 604 by analyzing the page pixel by pixel, using auto fill-filters to detect content boundaries, and/or using confidence metrics when analyzing complex content on the page to identify size, shape and location of the content. Various other means and methods can also be used to detect the content on the page. Once the content is detected, the page background can be detected, also in step 604. The page background can be the area of the page that is not content. In step 606 the page background is sampled. Sampling can be of a particular pixel, a grouping of pixels, a portion of the page background or the entire page background. Sampling of the page background can include analyzing the background attributes such as color, lightness, brightness, luminosity, saturation and/or contrast, among other similar visual attributes of digital media. The sampling performs sufficient analysis to be able to render an extended background that looks substantially similar to the page background near the area where the extended background will be displayed. After sampling, in a step 608, the method renders the extended background adjacent the page background so as to make a seamless visual background appearance on the display of the electronic device. Process 600 can be repeated for each page in a digital media, when there are multiple pages, to detect all the content in digital media and end in a step 610.

FIG. 7 is a block diagram of a computing device 1000 that can represent the components of the electronic device. It will be appreciated that the components, devices or elements illustrated in and described with respect to FIG. 8 may not be mandatory and thus some may be omitted in certain embodiments. The computing device 1000 can include a processor 1002 that represents a microprocessor, a coprocessor, circuitry and/or a controller for controlling the overall operation of computing device 1000. Although illustrated as a single processor, it can be appreciated that the processor 1002 can include a plurality of processors. The plurality of processors can be in operative communication with each other and can be collectively configured to perform one or more functionalities of the computing device 1000 as described herein. In some embodiments, the processor 1002 can be configured to execute instructions that can be stored at the computing device 1000 and/or that can be otherwise accessible to the processor 1002. As such, whether configured by hardware or by a combination of hardware and software, the processor 1002 can be capable of performing operations and actions in accordance with embodiments described herein.

The computing device 1000 can also include user input device 1004 that allows a user of the computing device 1000 to interact with the computing device 1000. For example, user input device 1004 can take a variety of forms, such as a button, keypad, dial, touch screen, audio input interface, visual/image capture input interface, input in the form of sensor data, etc. Still further, the computing device 1000 can include a display 1008 (screen display) that can be controlled by processor 1002 to display information to a user. Controller 1010 can be used to interface with and control different equipment through equipment control bus 1012. The computing device 1000 can also include a network/bus interface 1014 that couples to data link 1016. Data link 1016 can allow the computing device 1000 to couple to a host computer or to accessory devices. The data link 1016 can be provided over a wired connection or a wireless connection. In the case of a wireless connection, network/bus interface 1014 can include a wireless transceiver.

The computing device 1000 can also include a storage device 1018, which can have a single disk or a plurality of disks (e.g., hard drives) and a storage management module that manages one or more partitions (also referred to herein as “logical volumes”) within the storage device 1018. In some embodiments, the storage device 1018 can include flash memory, semiconductor (solid state) memory or the like. Still further, the computing device 1000 can include Read-Only Memory (ROM) 1020 and Random Access Memory (RAM) 1022. The ROM 1020 can store programs, code, instructions, utilities or processes to be executed in a non-volatile manner. The RAM 1022 can provide volatile data storage, and store instructions related to components of the storage management module that are configured to carry out the various techniques described herein. The computing device 1000 can further include data bus 1024. Data bus 1024 can facilitate data and signal transfer between at least processor 1002, controller 1010, network interface 1014, storage device 1018, ROM 1020, and RAM 1022.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable storage medium. The computer readable storage medium can be any data storage device that can store data, which can thereafter be read by a computer system. Examples of the computer readable storage medium include read-only memory, random-access memory, CD-ROMs, HDDs, DVDs, magnetic tape, and optical data storage devices. The computer readable storage medium can also be distributed over network-coupled computer systems so that the computer readable code is stored and executed in a distributed fashion. In some embodiments, the computer readable storage medium can be non-transitory.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An electronic device for displaying digital media having a page with a page aspect ratio, the electronic device comprising:
a display for displaying the page, the display having a display aspect ratio;
memory configured to receive and store the digital media; and
a processor configured to:
analyze the page to detect content and a page background on the page, the page background being the areas of the page that are not content;
determine if a portion of the display will not be filled with background or content when displaying the page; and
render an extended background that looks substantially similar to the background for displaying with the page on the display.

2. The electronic device of claim 1, wherein the extended background is rendered by sampling a value of the page background.

3. The electronic device of claim 1, wherein processor is further configured to determine if the page aspect ratio does not match display aspect ratio and displays the entire page with the extended background to fill the display.

4. The electronic device of claim 1, wherein the display displays the content in an enlarged state, a portion of the background and the extended background to fill the display.

5. The electronic device of claim 4, wherein when the content is displayed in the enlarged state the content is further displayed in a parallax effect.

6. A method for rendering an extended background to fill a display of an electronic device for displaying digital media including content and a page background, the method comprising:
detecting content on the page and the page background, the page background being the areas of the page that are not content;
sampling the page background; and
rendering an extended background to be displayed next to the page background when the page does not fill the display.

7. The method of claim 6, wherein sampling of the page background is performed at a portion of the page adjacent an area of the display where the page will not fill when the page is displayed on the display.

8. The method of claim 7, wherein the portion of the page sampled is both a top portion and a bottom portion when a top area and bottom area of the display are not filled with the page background when the page is displayed.

9. The method of claim 7, wherein the portion of the page sampled is both a left portion and a right portion when a left area and right area of the display are not filled with the page background when the page is displayed.

10. The method of claim 7, wherein the sampling of the page background includes evaluating a measure of at least one of a color, brightness, contrast, luminosity and saturation.

11. The method of claim 6, wherein the content is displayed in prominent state.

12. The method of claim 11, wherein the prominent state includes a parallax effect and/or an enlarged state.

13. The method of claim 12, wherein the page comprises multiple pieces of content that are each displayed in the prominent state and the multiple pieces of content can be displayed on different layers that have varying parallax effects.

14. The method of claim 13, wherein the multiple pieces of content can overlap.

15. The method of claim 14, wherein the digital media is a comic book, and the content includes graphics panels on the page.

16. The method of claim 15, wherein the content can further include text bubbles that are displayed in parallax effect.

17. A non-transitory machine-readable storage medium configured to store instructions that when executed by a processor of a computing device having a display cause the computing device to perform steps that comprise:
reading a page of digital media having content and a page background, the page background being the areas of the page that are not content;
determining the page background attributes at the page edges; and
rendering an extended background using the background attributes to be displayed next to the page edge when the page does not fill the display,
wherein the page edge and extended background are substantially similar.

18. The non-transitory machine-readable storage medium of claim 17, wherein the background attributes include at least one of a color, brightness, contrast, luminosity and saturation.

19. The non-transitory machine-readable storage medium of claim 17, further comprising the step of applying a parallax effect to the content when the content is displayed on the display.

20. The non-transitory machine-readable storage medium of claim 17, wherein the page include multiple pieces of content and applies a parallax effect to each multiple piece of content when displaying more than one piece of content on the display.
